(19) United States
(12) Patent Application Publication
(10) Pub. No.: US 2014/0229258 A1
(43) Pub. Date: Aug. 14, 2014

(54) SYSTEMS AND METHODS ENABLING TRANSPORTATION SERVICE PROVIDERS TO COMPETITIVELY BID IN RESPONSE TO CUSTOMER REQUESTS

(71) Applicant: Malak Seriani, New Milford, NJ (US)

(72) Inventor: Malak Seriani, New Milford, NJ (US)

(21) Appl. No.: 14/182,154

(22) Filed: Feb. 17, 2014

Related U.S. Application Data
(63) Continuation-in-part of application No. 13/049,379, filed on Mar. 16, 2011, now abandoned.

(51) Int. Cl. G06Q 30/08; G06Q 50/30

(52) U.S. Cl. CPC G06Q 30/08; G06Q 50/30
USPC 705/14.23; 705/26.3

(57) ABSTRACT

The invention provide means for enabling customers to request bids from various service providers in one or more virtual marketplaces created by an administrator, principally for transportation services such as taxis and limousines, delivery and cargo transport operations. In turn, customers receive a list of quality bids, filtered and ranked for various optimizing criteria, in a personalized bid display portion of a user application on a handheld device or PC. And, means for enabling service providers to access and interact with customers after a transaction produce highly personalized and customizable relationships, in part by incorporating elements of a social media platform and including positive incentives, thereby enabling both customers and service providers to benefit from increased efficiency and personalized control. Said incentives typically comprise relevant offers and related commercial opportunities, and thus the invention provides value-added features making it economically attractive for customers and service providers to use.

### CONTINUITY DATA

This application is a Continuation In Part (CIP) of, and claims the priority benefits of, U.S. Non-Provisional application Ser. No. 13/049,379 to Seriani filed on Mar. 16, 2011 and U.S. Provisional Application No. 61/358,037 to Seriani filed on Jun. 24, 2010, according to 35 U.S.C. §120 and 35 U.S.C. §119(e), respectively. Each of these applications is hereby incorporated by reference in its entirety for all purposes.

### BACKGROUND OF THE INVENTION

1. Field of the Invention

The present invention relates to methods and apparatus that enable users to request competitive bids for travel and transportation services such as taxis, limousines, delivery vehicles, or other service providers offering various means for transporting people and cargo. More particularly, the present invention combines improvements relating to auctions as defined in US Classification group USPC 705/26.3 as applicable to transport services, and further comprising features of a social media platform and of an advertisement or merchandising platform, among other innovations.

2. Description of the Related Art

The following review of related art is intended to provide edifying examples of problems and pitfalls in the design and use of auctions relating to transport and travel services. The mention of these examples does not constitute an admission that any of the following methods or devices constitute prior art applicable to the present invention. The discussion of the references states what their authors assert, and the applicant reserves the right to challenge the accuracy and pertinency of any of the documents cited herein.

Numerous attempts have been made to make the experience of hailing a cab, or ordering ad-hoc transportation services, a precise and automatic experience for customers and service providers alike. Nevertheless, the systems and methods in use today for connecting customers seeking everyday travel and transport services with the most suitable service providers in a given situation remain inefficient and relatively unchanged over the past two decades, despite the adoption of some internet-based auction platforms and competitive bidding hubs, according to the prior art reviewed below. Service providers are finding little incentive to subscribe to such systems rather than to continue their traditional means of locating customers, and at the same time, the experience of customers using such systems tends to be negligible and even negative, involving greater confusion, effort, and costs than those incurred by simply dialing a telephone number and blindly asking a human dispatcher to send whatever the dispatcher can locate according to the approximate needs of the customer. It would be advantageous to incorporate into existing auction systems more effective and vitalizing incentives for both customers and service providers in order to drive both groups to automated systems, but the prior art has thus far failed to fulfill this vision.

U.S. App. Pub. No. 20010056396 to Tadashi Goino, entitled “Auction methods, auction systems and servers,” published Dec. 27, 2001, provides for an auction system that enables users to specify detailed parameters relating to desired times, dates, and conditions of an offered auction item, where said auction item comprises things ranging from antiques and other merchandise to taxi services. This invention confines itself to solving the problem wherein “sellers and buyers who look for counterparts to buy or sell articles have a variety of desires for trading dates [or other criteria] such as the article delivery date, it [sic] the payment due date, and so on in accordance with individuals' circumstances[; however], [c] onventional auction methods [ ] determine a successful bidder without considering such trading dates” (Goino at [0004]). Therefore, Goino is less concerned with providing improved transactions between travelers and transport service providers, and is more concerned with enabling auctions to accommodate time-sensitive and circumstance-dependent limitations. While this innovation may enable existing auction systems to incorporate auctions comprising taxi service, it does not address the specific deficiencies that have heretofore made such auction systems unattractive and ineffective, which is why they have not been adopted on a large scale. For example, Goino does not improve the speed or transparency of the bidding and feedback mechanisms necessary to convince customers to use such a system, nor does it diminish the burdens, such as those involving membership expenses and account management time drains, necessary to attract service providers to enroll in such auction systems, nor does it significantly improve the performance of the service provider's business in real time when reduced to practice. Like virtually all auction systems proposed in the prior art, Goino creates a lot of extra work, without offering new and better ways to improve the quality of service or the amount of profit to be made, for transportation service providers.

Likewise, U.S. Pat. No. 6,756,913 to Ayed, entitled “System for automatically dispatching taxis to client locations,” issued Jun. 29, 2004, describes means whereby: “After determining [ ] client location data, a processor searches the available taxis database for a taxi whose location matches the client's location [and then] [t]he client location data is converted to an address and sent to the assigned taxi, [and then] [t]he address is displayed on a mobile data terminal in the taxi. This merely eliminates the human dispatcher by substituting a computerized application therefor. Customers are therefore presented with less transparency while service providers are required to pay for owning a data terminal without receiving any added ability to locate and incentivize customers beyond that already provided by the prior art.

The invention disclosed in U.S. Pat. App. Pub. No. 2004/0260470 to Rast, entitled “Conveyance scheduling and logistics system,” published Dec. 23, 2004, seeks to add value to their automated dispatch system by providing disincentives for customers and services providers in the form of penalties for failure to perform on a contract for the agreed upon services, but this only increases the risks faced by participants without adding positive incentives. Separately, U.S. Pat. App. Pub. No. 2006/0059023 to Mashinsky, entitled “Method system and apparatus for providing transportation services,” published Mar. 16, 2006, attempts to provide positive incentives to their system in the form of cash rewards to service providers who receive positive feedback, which increases the cost of service (because it must inflate to accommodate the value of the cash incentives) and therefore is unnecessarily expensive. Mashinsky is basically a complicated means for tipping a driver, which is already easy to do in person on-site.

The “Taxi dispatching system and dispatching method” proposed by Umeda in U.S. Pat. App. Pub. No. 2006/0034201, published Feb. 16, 2006, the entirety of which is hereby incorporated by reference herein, provides improved auction methods without addressing the issue of incentives or value-added features, but is nevertheless instructive as a means for efficiently automating a taxi dispatching operation. Umeda focuses on the essential elements of bidding for taxi service, but does not extend beyond the mere recapitulation of existing procedures in the industry. Similar rationale applies to U.S. Pat. App. Pub. No. 2005/0143095 to Jacob, entitled “Method and apparatus for delivering services,” published Jun. 30, 2005, the entirety of which is hereby incorporated by reference herein and to U.S. Pat. App. Pub. No. 2008/0189148 to Diaz, entitled “Ground Transportation Booking,” published Aug. 7, 2008, the entirety of which is hereby incorporated by reference herein.

Despite the extensive range of possibilities available in the arts of online service provider tools, very few features offered by third party products have been brought to bear against the issue of incentivizing the adoption of automated bidding systems in transport services. One exception is the integration of GPS, mapping algorithms, visual geolocation software, and other applications of geolocation technology. Providing location data automatically may be useful and attractive to both customers and service providers, such as in U.S. Pat. App. Pub. No. 2008/0147450 to Mortimore, entitled “System and Method for Contextualized, Interactive Maps for finding and booking services,” published Jun. 19, 2008, the entirety of which is hereby incorporated by reference herein. However, the community of inventors in the prior art has neglected to consider the fact that a transportation service episode is an ideal opportunity to direct other and different types of content and services at a captive audience (i.e., at passengers) and an opportunity to exchange information, share experiences, and make friends, so it would be useful if these platforms were modified to accommodate a broad range of services and information technology applications like those available via social media platforms.

In light of the above, there exists a need for novel systems and means for enabling bidding to occur in rapid response to customer requests for transportation services where the bidders, who are by nature repeat bidders as members of the system and as professional service providers, have established an identity visible to other users of the system in a way that is somewhat analogous to a social media application. Rather than perceiving one round of bidding as a one-off auction event for a single item of a good or a single instance of a service, as do prior art transportation auction systems, the present invention provides a system that develops lasting relationships comprising on the one hand customers seeking a particular type of service provider-experience and on the other hand member service providers who have established (and are continually establishing) an identity via a social profile within communities within the system. Social media can be generally defined as herein as it is by the internet encyclopedia, Wikipedia, encompassing a means for providing methods and applications enabling interaction among people in which they create, share, and/or exchange information and ideas in virtual communities and networks.

By incorporating social media features, the software platform and applications of the present invention enable geographically distributed customers to interact with a community of member bidders comprising service providers having a permanent stake in their reputation, also enabling them to interact via any wireless communication or computer-implemented means before, during and after the provision of the service to thereby provide additional value over and above the mere auctioned transaction of a single instance of a transportation service. The present invention incorporates a host of other value-added features, including but not limited to intelligently calculated “Recommended Bid Prices,” incorporated gift and rebate programs hosted by third party providers in order to reward and incentivize both customers and drivers, and means for displaying advertisements within an application that resides on users' existing personal electronic devices. The present invention also enables developers to customized and modify its functionality by means of integration through Application Program Interfaces (API's) as understood by persons of ordinary skill in the arts of popular software development.

Because current applications only show service providers in a geographic location with approximate cost of service, there is a long-felt need in the prior art for an automated system providing the above improvements. Furthermore, it is desirable to provide a system wherein unregistered users can submit a request for service and receive bids back from registered users (e.g., service providers), where both parties gain value in greater measure than they lose value by using the system, and which can integrate with the existing mode of computer usage already adopted by customers and service providers, such as the social media and shopping features of the present invention. Furthermore, an improved system should intelligently combine informatics relating to present and past performance and real-time cost parameters to maximize profits and customer satisfaction without raising fare prices or wasting time. Prior art systems are unnecessarily cumbersome, which is why the industry has overwhelmingly refused to adopt software based automated systems before now.

### SUMMARY OF THE INVENTION

The present invention satisfies the above needs and significantly improves the state of the art. Briefly, the present invention describes a software-implemented networked marketplace platform connecting customers and service providers in industries relating to transport services, while providing specific incentives and value added features that for the first time make the benefits of using such automated systems outweigh the costs, from the perspective of both customers and transport service providers. Through one or more marketplaces established on the platform by an administrator, customers and service providers may interact, request and receive bids for services, and conduct other social networking and commercial transactions.

It is a first objective of the present invention to provide means for enabling customers to request bids from various service providers, principally from providers of transportation services such as taxis, limousines, ferries, private airplanes, drones (unmanned vehicles), cargo transports, and other pay-for-service means for transporting passengers and/or cargo from a pick-up location to a drop-off destination. In turn, customers receive an optimized list of quality bids in a personalized bid display portion of a user application on a handheld device or personal computer. The invention provides means for service providers to access and interact with customers in a manner that enables highly personalized and customizable interactions, in part by incorporating elements of a social media platform and including positive incentives, thereby enabling both customers and service providers to benefit from increased efficiency and personalized control, plus programs offered by third-parties such as gift offers, shopping and merchandizing, advertisements, and other information technology tools.

It is a second objective of the present invention to provide a software application, accessible via the internet or installable on a personal computing device (e.g., a mobile phone, a tablet PC, a portable computer, etc,) that provides a platform for customers to request and receive bids from said transportation service providers, and to sort and/or arrange bids according to specified criteria, thus enabling said customers to intelligently, efficiently, and economically acquire a desired service from one or more of said service providers. The system adds value to the bidding process by intelligently presenting service providers with recommended bid prices and incentives to offer each individual customer, while providing customers with incentives, as described above, where said incentives typically comprise relevant, up-to-date offers and information calculated to apply to their trip or to their anticipated “needs and wants.” To mention one specific example: preferred embodiments of the invention comprise links to and advertisements for shopping resources that offer souvenirs, equipment, or other merchandise especially suitable for use in relation to the passenger's destination, where said destination may be not merely a location on a map, but also even a special event, an important appointment, or a place where the passengers are expected to engage in a particular activity.

It is a third objective of the invention to enable users on both ends of the platform of the platform to extend their interactions into other areas of interest, web-based forums, or into future transactions together by means of optional messaging and social media options. Furthermore, individual software developers will assist in the implementation of the invention, which is already laden with incentives for its adoption, by virtue of the software being amenable to limited open-source modification and integration with other web-based application via Application Program Interfaces (API's) as understood in the art of consumer software development.

### Not Merely an Auction System:

The present invention does not provide for a true auction system, because several exceptions apply. Firstly, it is expected that the customer requesting service will select a winning bid from among the bids submitted by service providers which has the lowest price, rather than the highest price, thus making this a “reverse auction” or “counter-auction.” Secondly, the winning bidder will not necessarily be determined by a single criterion such as the lowest bid price, but rather additional criteria will come into play, such as: a bidder's reputation, a bidder's present proximity to the requesting customer and his or her ability to meet the customer's subjective secondary criteria such as stowage capacity, vehicle type, the driver's presentation of appealing social media content, a driver's credentials and feedback history, and/or the bidder's provision of incentives comprising one or more of rebates, gift options, or other value-added options, in addition to providing a competitively low fare price. In other words, customers are selecting for both objective and subjective criteria, comprising an ideal bid price as well as optimal secondary factors relevant to the expected quality and likeability of the provider and his or her services. This makes the present system more of a true marketplace rather than a pure bidding system.

Additional objects, features, and advantages of the present invention will be more readily apparent from the following detailed descriptions of some preferred embodiments thereof. The present invention is not limited in its application, details, or components merely to those set forth in the following description and illustrations. The present invention resides not merely in any one of the features set forth in this specification, but also in the particular combination of all of the features and improvements claimed. Methods and devices consistent with the present invention are capable of other embodiments. In general, the order of the steps of disclosed processes may be altered within the scope of the invention. Also, the phraseology and terminology employed herein are for the purpose of description and should not be regarded as limiting unless explicitly stated as such.

### BRIEF DESCRIPTION OF THE DRAWINGS

FIG. 1 is a schematic diagram illustrating a system of the present invention.

FIG. 2A is a schematic diagram representing a Customer Request Submission Form available to customers through the platform of the invention.

FIG. 2B is a schematic diagram representing an Incoming Request Alert Form sent to Registered users in response to the Request submitted by the customer which invites the Registered User to submit a Bid.

FIG. 3 is a schematic diagram representing an account creation and management feature of the system of the invention whereby Registered Service Provides may supply identifying information and specify functional parameters governing their access and use of the system.

FIG. 4A is a schematic diagram representing a Bid Selection form displaying incoming bids to a requesting customer.

FIG. 4B is a schematic diagram representing a contract formation means for certifying the acceptance of a winning bid.

FIG. 5 is a schematic diagram illustrating a user profile of a Registered Service Provider of the platform and comprising various value-added and interactive social media features of the invention.

FIG. 6 is a schematic diagram illustrating a sequence of steps in a method for establishing a system comprising features of the present invention.

### DETAILED DESCRIPTION OF THE DRAWINGS

Accordingly, the present invention provides several embodiments and variable configurations of systems as introduced above and set forth in the detailed drawings and descriptions below. Throughout all the drawings, same or corresponding elements are indicated by the same reference numerals.

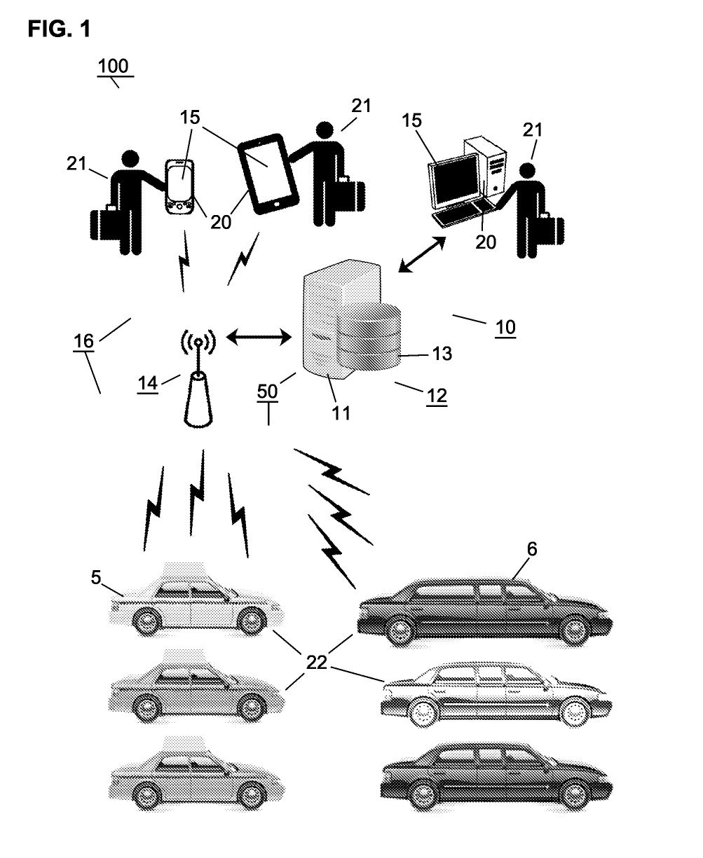

In a first preferred embodiment of the system 100, an overview of which is illustrated in the schematic diagram of FIG. 1 and which happens to be optimized in this example for taxi 5 or limousine 6 service, the invention comprises a network communication means 14 and computer processing means 11, including at least one server 13 or equivalent apparatus, which are adapted to provide a computer-based platform 10 wherein a centralized application and logic means 12 enable customers 21 to access the platform 10, said access occurring through a portable software product (a “user application” 15) such as a downloadable application, internet/web-based module, or any other software means for operating an application on handheld devices, home computers, or any consumer electronic device 20. At the top of FIG. 1, three distinct customer 21 users have the user software 15 installed and running on their respective computing devices 20, wherein they are accessing the platform 10 and system features of the invention operating in conjunction with the centralized application 12 to each submit a service request in expectation of receiving one or more responsive bids from presently available and appropriately qualified service providers 22 who are eligible to receive notifications of the service request and opportunities to bid in response by interactions taking place in a virtual marketplace 16 which can be generally defined as a collection of entities interacting via these features and functions.

Typically, the customer is an anonymous bidder, that is: the customer is not a registered member of the system to which the software pertains or is a registered user but is submitting a prospective bid request anonymously. It is an advantage of the present invention, and an incentive for customers to use it, that customers need not provide personal identification information to either the system and/or to the bidders/service providers until after accepting a bid from one of them. This diminishes customer costs in terms of time, risk, and inconvenience, and it differs from the prior art which requires such information up front and consequently is repulsive to new adopters of such automated transaction platforms. Consumers are generally reluctant to spend time entering information before experiencing the benefits of an application on the web or other public network and even more reluctant to expose themselves to spam and other risks associated with divulging an email address or other data until after they have decided to reap the benefits provided by the system demanding such information. The present invention establishes a marketplace having a community of reliable and accountable registered service providers, while giving users the option to divulge as much or as little personal information as desired, and therefore it provides a unique extra layer of protection, assurance, and comfort for its users.

A single platform 10 may be configured to operate multiple and interconnected/overlapping marketplaces 16, as would be familiar to a person of ordinary skill in arts relating to hosting online communities and marketplaces. For example, the taxi service providers 5 may be part of one marketplace, while the limousines 6 constitute another, and the system logic 12 of the system has parsed the service request to conclude that the customer may find eligible service providers in either marketplace, so both are included in the transaction. It is advantageous to be able to operate multiple marketplaces from one platform because a single administrating organization may establish a variety of communities while enjoying an economy of scale, and it affords maximum control and flexibility required to best satisfy the demands of diverse consumers. For example, a single management company may operate both a taxi service marketplace and a commercial shipping marketplace from one office, one platform, and one server, thus satisfying the operational objectives of three different businesses in one infrastructure.

Transportation service providers participating in the marketplace are always registered users having verified accounts comprising important personal identifying data, to be explained in greater detail below. The term “transportation service provider,” or simply “service provider,” is defined broadly herein to encompass any provider of services for moving persons or cargo from a Pick-up Location to a Drop-off Destination, or a “From” and a “To” parameter, whether they be an individual driver or an organization or business providing such services. Customers are anyone using the system to request a service, whether registered or unregistered. An unregistered customer is first identified by location, either or both by an automatic geolocation means such as a GPS transceiver inherent in their personal device 20 and/or by manual entry of location information into fields of a computer-implemented fillable form (such as when using the keyboard of a computer and while interacting with a graphical user interface of the application of the invention) provided by the user application 15, or by IP address, software cookie, or any other means for establishing a network identity for a human actor; whereupon said location information is stored by the system as a first “Pick-up Location” component of an Itinerary parameter pertaining to the requested service. The unregistered user will at this point be identified by the application according to this location and optionally by the time when the location was provided to the system of the invention. This time will represent a default Pick-up Time until modified.

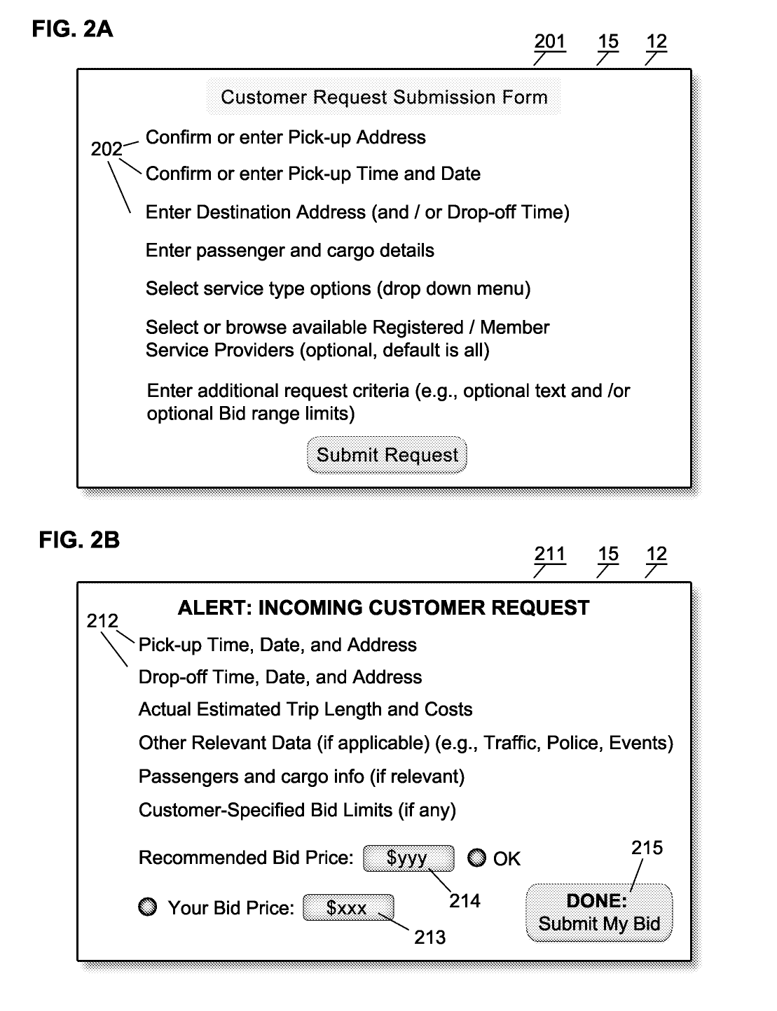

FIG. 2A is a schematic diagram illustrating a “customer request submission form” 201 comprising a typical set of data fields 202 for display in the user interface of a service-request submission means of the user application 15, which is a subcomponent of a bidding mechanism of the platform 10 and logic 12 thereof. The system will request from said unregistered user specific information about the goal of the desired transportation service, where said goal information must comprise a “Drop-off” address or a Destination parameter, and may also at this point require information about the number of people included in the trip, the nature, quantity and content of any cargo to be transported, time constraints before and after which the trip is or is not desired, and other secondary criteria such as the type of vehicle demanded or preferred, the characteristics and qualifications of the driver/operator demanded or preferred, and the presence of any positive or negative feedback provided from previous customers demanded or preferred, and the like. In preferred embodiments, the prompts to supply secondary criteria are compiled into the fillable form based upon a previously selected “Service Type” option (menu item not shown) that appeared on an introductory screen of the user interface, so that extraneous questions are avoided in the fillable form and so that relevant questions are populated therein; for example, if a customer is making a request for bids on a “local taxi ride,” secondary criteria are unimportant, whereas a person selecting “Stretch Limousine Service,” or “Airport Transportation” will encounter at least some additional questions up front. An example of an ensuing notification of the request (“incoming bid alert” 211) which shall be sent to one or more eligible service providers informing of the opportunity to bid is presented in the schematic diagram of FIG. 2B.

Location and Destination information generally comprise a city, state, and street address, and may optionally comprise brief location-specific and trip-specific descriptors such as “house or apartment,” or “waiting outside,” or “please honk,” “please call,” “please ring doorbell,” and the like. According to optionally-implemented features of the application, it may be enabled to reconcile input with stored database records, such as via logic encoding means for reconciling the Location and Destination address information with a database comprising a directory of addresses and/or maps of the geographic region to verify that they can be known unambiguously, and to request clarification if necessary. And, the features requesting the unregistered user to input secondary information may also be reconciled according to any database or series of parameters as would be understood by persons of ordinary skill in the art of generating user-fillable forms and software for requesting user-specified data for application in downstream computer-implemented functions. Any detail included in a service request may be referred to as a “service request parameter,” and for illustration purposes each field 202 may be regarded as representing a distinct service request parameter.

Any customer may choose to become a registered customer, in which case the software application will auto-fill certain fields of the fillable forms throughout the bid requesting and selecting process. Thus, repeat users of the system may not necessarily be restricted to providing their information anonymously each time they request bids for a specific instance of transportation service, but rather such user-identifiable information may be stored in a user account, which is created by the same general means as for the service provider, but with different types of information and features, according to the discretion of the administrator.

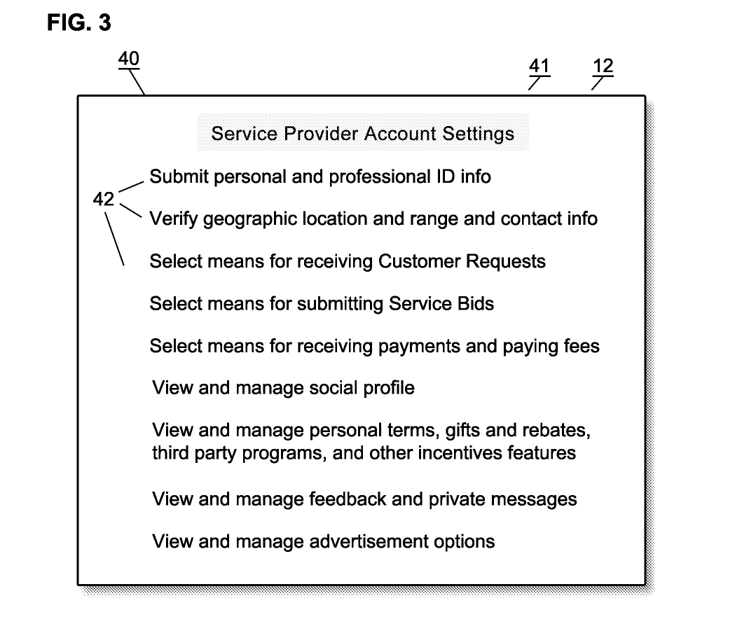

On the server side of the networked application 12 of the invention, an administrator or hosting agency (not shown) has established a database comprising one or more listings of service providers 22 and these can be organized by secondary criteria such as zip code, types of vehicles, and any other parameter. A service provider joins by creating an account and agreeing to terms, and typically also by agreeing to some sort of membership fee payment scheme, the details of which are specified by each individual administrator. A diagram illustrating a set of fields or parameters in a service provider account 40 is illustrated in FIG. 3. A service-provider registration means 41 enables each to enter and update personal information, credentials, preferences, and other service-provider data 42 parameters, and the entry of these data via the registration means 41 constitutes several steps in a method for creating a service-provider account 40. In general, service provider data comprises personal identifying information and preferences or account settings, such as forms and methods of payment accepted from customers, preferences relating to the mode for receiving alerts and submitting bids on the platform, minimum and maximum values for distances willing to drive, or any other variable that may be established by an administrator pertaining to business conducted in a virtual marketplace. In preferred operations, registered service providers must provide verification of some data, including but not limited to identifying information, contact information, license data, behavioral and criminal history, a photograph, vehicle information such as registration and service history, and so on. Such verified parameters are a type of “value-added parameters” of the invention that increase the value of its use in many ways, including: because they reduce the liability and uncertainty of owners regarding the personal histories of their registered drivers and platform clients, they prevent fraud, provide proofs of licensure, and they also increase customer satisfaction by making it more likely that each requesting customer will receive quality service and will have accurate, high-quality information upon which to base their decisions when choosing a winning bidder. Such value added parameters may include, for example, official documentation such as a license, a citation, or a certificate of qualification. The stringency of these requirements, and the number and type of the total set of parameters 42 required by the registration means 41, may be adjusted by the administrator, and may be customized according to the exigencies of each marketplace. Other value-added parameters comprise incentives offered by registered users in order to increase the competitiveness of their bids, to be discussed separately below in the context of incentivizers.

In preferred embodiments, the registered users pay a fee for being given access to the system of the invention, which includes the privilege of maintaining a personal profile 51 on the system, and which fee may qualify a registered user service-provider to participate in one marketplace or a plurality of marketplaces, where the marketplaces are tailored to the needs of particular types of consumers (and most likely also advertised to them by the owner or administrators or other residual claimant having authority over the system) or tailored to one or more particular types of transportation services, such as taxis or commercial delivery services, to name only two examples. Said fee(s) may be applied as a regular payment (e.g., monthly, yearly, etc.) or on a per-transaction basis (e.g., a listing fee or a percentage-based commission charge). Registered service providers must declare their availability for any given time period in order to receive alert notifications of available customer requests (i.e., “opportunities to bid”). Declaring availability may be accomplished by logging into a user account 40 and changing a status parameter 42, or it may be done automatically by the use of any means for detecting a status known in the relevant arts, such as by third-party devices like a GPS tracking element, by text messaging to a platform operator, by a downstream command of an employee time-clock apparatus, and so on. API's and administrator options, or other software plug-ins and patches can be incorporated in the platform to enable it to receive availability input data from virtually any external source. Availability parameters may include a Boolean “on duty” or “off duty” parameter as well as location, time, activity, and any other relevant criteria. Other availability indicators may comprise a calendar application which can be applied to prospective customer requests when planning future pick-ups, special authorizations that make a service provider eligible to work at or in a particular event or venue, such as a concert, stadium, or gated community, the ability of a driver to speak a certain foreign language (thus establishing eligibility for a customer requesting a driver facile in that language), and vehicle information ranging from manufacturer specifications (e.g., make, model, year, seating capacity, air conditioning, airbags, stowage capacity, passenger seating capacity, etc.) to individual customizations (e.g., audio system, aesthetic features, ruggedization such as for off-road or cross-country trips, etc.), and so on.

Throughout this disclosure, generally, features and parameters which are relevant to eligibility, bidding, and service requests are mutually compatible across the various other types of parameters. Any of these may be applied as “eligibility” criteria with respect to bidding, and their pertinence may vary from one marketplace to another according to the discretion of the respective administrator(s). Notice of opportunities to bid on an incoming service request are automatically distributed by the platform via logic means for matching request criteria with provider credentials (as derived from service-provider data stored in the account) where eligibility may comprise a score derived comparatively based upon some credentials but qualitatively (e.g., strictly eligible or strictly not eligible) for other credentials, such as the obvious example of “on duty.” For example, two drivers of two suitable vehicles who are on duty and within a certain distance from a requesting customer may be eligible while a third driver may be in a suitable vehicle and within range but off duty and therefore not eligible. In some implementations, registered users may be required to allow the system to track their location and even to publish such information, such as publishing to the personal profile 51.

Furthermore, each registered service provider has account options that may be adjusted to filter and specify the types of requests they are offered or exposed to by the system, where the options relating thereto correspond to the details available in the service-request input 202 described above (e.g., city, location, vehicle type, cargo space, suggested price range, etc.). When registered service providers are logged in or otherwise available to customers, they are notified of incoming customer requests by an alerting means of the bidding mechanism using any means for sending an alert message known in the art of network communications including but not limited to SMS, text message, email, phone call, instant message, etc., and these messages may be sent within the application of the invention or separately by third party communications services. Each customer request is time-sensitive, reflected by a time limit specified by the administrator and/or driver during which the service provider must respond with a bid in order to participate in that round of bidding. Responsive bids may also be parsed and filtered for eligibility criteria, as explained for alert notifications above, to ensure that they qualify with the customer's specified request parameters. For example, a registered user who is not verified as providing limousine service may not bid on a customer request for transportation of more than four or five people (a limitation imposed by various local laws relating to taxi sedan service in most locales). Other eligibility criteria may be merely pragmatic, such as when a driver is too far away from the pick-up location to arrive in a reasonable amount of time. The bid parsing means is flexible for specifying the criteria used when reconciling service request parameters with eligibility as part of the platform, and it will make such determinations according to the administrator's settings for the marketplace, so that the group of responsive bids returned to the requesting customer comprise the most profitable, safe, and satisfactory of the total potential bid pool.

Thus, unlike an auction, not every bid submitted in response to a service request will end up being seen by the requesting customer or being offered to the potential customer by the platform. This advantageous feature improves over the prior art wherein a single bid request is typically answered with an inconveniently large number of options, and often an additional result is further inconvenience when responsive bids are not thoroughly parsed and pruned, because the requesting customer lacks sufficient quality information to differentiate among the many responsive bids or to evaluate each of them accurately. The present invention solves these problems and thus dramatically optimizes the state of the art, making methods that were previously unattractive now convenient and loaded with value-added features.

The availability and eligibility data parsed via the bidding mechanism of the system can be custom tailored by the administrator to enable a marketplace to be optimized for any particular type of customers or services, because almost any type of eligibility data may be used and applied in calculations to output the most responsive and excellent bids in the bid display mechanism that is sent back to the customer. Upon submitting a service request, in preferred embodiments the prospective customer is anonymous, but eligibility-related questions may be asked where appropriate or necessary to enable the eligibility determinations to be made by the parsing means. On the other side of the relationship, the resulting alert for notifying eligible service providers of an opportunity to bid may be structured to contain only those fields necessary to enable the service provider to quickly estimate and respond with a competitive fare. The parsing means of the invention thus intervenes intelligently between requester and bidder to accelerate the transaction, hiding extraneous information from the transacting parties while making use of a broader range of information internally, applying automated means to make the most effective decisions, particularly the decisions that determine which bidders shall be ranked as the most eligible to receive an alert and which of their responsive bids shall be ranked as the most-probably attractive to the customer.

FIG. 2B is an example of an alert notification 211 output of the alerting means of the bidding mechanism, comprising a schematic representation of an interactive SMS, instant message, email, or other digital transmission which has been sent from the platform (after parsing) to an eligible service provider. A summary list of relevant data 212 are sent in an easily readable format, where said alert data 212 comprise service request parameter data and (optionally) value-added bid alert notification parameters such as “actual estimated trip length (in miles and/or time,” trip cost in gasoline dollars, and the like. The purpose of the alert data is to prepare the eligible bidder to (1) determine whether it is worthwhile to bid at all and (2) how much to bid in order to be competitive; therefore, any bid alert notification parameters that impinge on these decisions are contemplated here as part of the invention. When submitting a bid, the bidder may manually submit a responsive bid 213 on his or her own terms, or alternatively, he or she may accede to a “suggested” or “recommended” bid price 214 that an artificial intelligence of the bidding mechanism generates according to calculations based on factors established by standard practice in the relevant industry and as modified by the administrator, including but not limited to known averages based on aggregate data for similar trips in the area, on the pool of bids presently being provided for the same or similar trips, and the like. This advantageous feature of the present invention adds value to the system by helping each bidder to be competitive and presently informed of price changes pertaining to particular routes or dates in a given location, and also simplifies the bidding process. This is one means by which membership in the system increases the productivity and profitability of members and thus justifies membership costs and encourages adoption.

The responding service provider must actively (as opposed to blindly) submit a bid 215 in response to the alert of a bid opportunity in order to participate in a particular round, where the requirement for active submission is intended to prevent unscrupulous actors from automatically taking bids while engaged in a service call (double-booking). Eligibility decisions thus are protected from fraudulent transmission of availability criteria data. Service providers are able to respond only to requests for service in pre-defined grid in a pre-set time period, or according to any general eligibility scheme asserted by the administrator.

The administrator may actively tend to the administration options available on the platform, but the invention anticipates that in most cases the administrator will set up each marketplace according to a declared set of rules, limits, ranges, and parameter types, and then let it run according to those settings for an extended period of time, until it becomes desirable or necessary to make a change. The platform provides an administrator control means comprising an administrator log-in mechanism and one or more interactive menus, forms, and access means for establishing and governing a marketplace. The administrator may choose settings that affect the parameter types and logical operations (e.g., calculations, filters, comparisons, etc.) that impinge upon any step of the transaction, including but not limited to the means for submitting a customer request, means for parsing customer requests, means for determining eligibility, means for determining suggested bid price, means for parsing bids, means for ranking bids and organizing them into groupings to return to the requester, the information fields that are displayed in the bid-selection interface wherein the customer selects a winning bid, and so on. In its simplest mode, the system provides means for applying availability indicators to a bidding mechanism which, when availability criteria are set up by the administrator or supplied by a registered service provider, these data enable the bidding mechanism to intelligently determine which service providers from among all members in the marketplace community are eligible to receive an opportunity to bid on a given customer request.

The means for submitting bids may be accomplished in several ways, typically via an electronic communication means. In a first way: the service provider receives a text message notification (or equivalent such as email, SMS, etc.) 211 from the alerting means of the platform, and then the service provider may respond by entering text or interacting with graphical controls according to methods dictated by the administrator and expected by the logic of the software of the system, such as by submitting alphanumeric text strings to be parsed by a bid parsing algorithm. For example, a bid may comprise a series of alphanumeric text strings separated by commas or semicolons, or separated by hashes, where the expected information typically comprises at least a #bid price, and may optionally include secondary information as described above and entered in sequential series, for example, #estimated time of arrival, #type of car, #coupons available, #current location (as further proof of the proximity relating to ETA), and so on. Alternatively, the alert notification 211 may be a fillable form. In the example of FIG. 2B, only fields for entering bid price 213 or 214 are shown, but additional fields could be present. The responsive bid is then returned to the platform via the bidder hitting a command key 215, and then the bid is parsed in preparation for its presentation to the requesting customer. The administrator may specify a set of value-added parameters for automatic inclusion in a responsive bid, which would be added by the parsing means and which may reference account parameters from the bidders registered account. There is no opportunity for the bidder to see personal identifying information of the requesting customer at this time, unless the customer has opted in for non-anonymity in a particular transaction. This opt-in feature is advantageous when a customer is a repeat customer and wishes to attract a competitive bid from a previously used service provider, but in most transactions, the bidding is done on an impersonal basis.

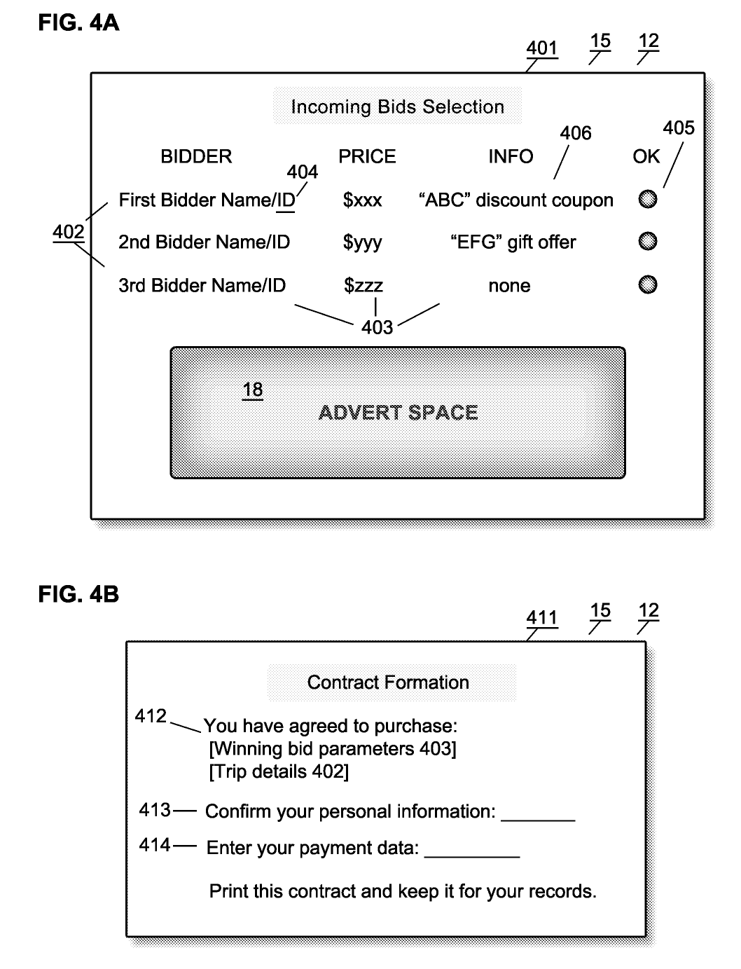

Bids are received and parsed by the software 12 of the system, typically at the server level, and then they are grouped and sorted according to various criteria, after which they are transmitted to the requesting customer in an an interactive display module 401 of the user's portable software 15, illustrated in FIG. 4. After the requesting customer receives the first bid, or a threshold number of bids, and/or after an administrator-specified time period elapses, he or she may accept one of the bids, which is the step of selecting a “winning bid.” This may be accomplished by a one-click option within the GUI of the software application, such as by activating one of the “OK” buttons 406 and then hitting a reply command key. Individual bids may also be set to expire after a certain time elapses, or they may be manually canceled if another bid is accepted while a prior bid remains pending. Preferentially, the system of the invention provides a calendar or dayplanner whereby a registered service provider may optimize his or her time usage and whereby automatic controls prevent double-booking.

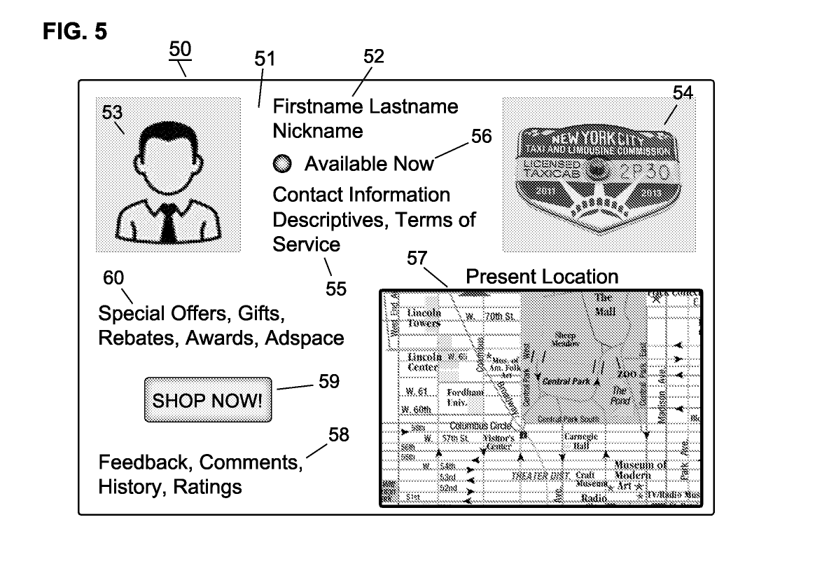

A responsive bid comprises the submission by the eligible service provider of a price for providing the service (the “bid price” 213 or 214), and optionally, information regarding the nature and the quality of the service such as the credentials of the driver or the quality of the vehicle, guarantees and coupons, rebates, or other consumer incentives, previous customer feedback, and the like (e.g., value added parameters and incentivizers). During a round of bidding, as a plurality of registered service providers submit their individual bids by responding to the bid opportunity alert notification they have each received from the system of the invention, and a bid evaluating mechanism of the invention may gather, compare, and filter the bids in preparation for their transmission to the requesting customer. Preferably, the requesting customer receives only a certain number of the most competitive bids, which is a value-added feature of the invention. As illustrated in FIG. 4, the group of responsive bids (the “responsive bid groupings”) 402 are displayed in the requesting customer's interactive graphical interface of the user application 15. The responsive bid display screen or module 401 comprises a simplified and ordered list of responsive bids 402 where one or more bid parameters 403 are displayed. This display comprises any visual representation of one or more of the bid parameters 403 of the bids in a bid grouping, which set of displayed bid parameters preferably includes the bid price and the bidder ID. FIG. 4 comprises text descriptions, but graphical symbols may be used equivalently to represent bid parameters. Each bidder ID comprises a hyperlink or other linking means 404 directed at the network address of the respective personal profile 51 of the bidder, which linking means 404 when activated will open a graphical display 50 (according to FIG. 5, below) showing said respective personal profile 51, where the customer may consider any other unique information and service incentives presented in said profile as additional factors to weigh in the decision process for choosing a winning bid from among the bid grouping. In addition, the bidder may offer a value-added parameter and/or incentivizing feature 406 to his bid, where a value added parameter comprises any useful or valuable service or information that may make a bid more attractive, ranging from membership in a club (as in a social networking environment), to advertisements, useful applications available through the network, brochures and tour guides applicable to the Destination of the trip, and the like; and where an incentivizer may comprise anything that effectively reduces the cost of the trip by adding a positive financial value to the transportation service contract, ranging from the hand-delivery of a coupon to the passengers after performance of the trip, to online access to special offers for goods and services from the service provider or any third party. During the bidding process, and/or after the customer selects a winning bid, feedback may be sent to the non-winning bidders about the present and final competitiveness of their bids to help them improve future performance and gauge the performance of their competition, thus providing another value-added feature of the invention. For example, the bidders may be granted the ability to see the same incoming bid display as that seen by the requesting customer.

Upon selecting a winning bid, the customer is required to submit personal identifying information so that a contract may be formed, where said information comprises at least a name, and preferably also at least a contact method such as a phone number. In some embodiments, the invention may facilitate payment for the service, and may require at this time that the user submit information relating to a payment method such as a credit card number. This payment method may be utilized to pay the service provider upon completion of the job or it may be held as a means of securing the customer's acceptance of the offer, or as proof of ability to pay for the requested service, for example: where the card will not be charged unless the user fails to appear for the pick-up or fails to pay upon delivery. This aspect of the invention is a distinct advantage incentivizing service providers to enroll in the system and adding additional value to registered user's enrollment in the service of the invention. Furthermore, the same payment method may be applied for later offers to purchase goods and services, thus facilitating such transactions and further enhancing the overall revenue-generating power of the system. The submission of personal information 413 and the submission of payment authorization data 414 by the customer, even if no payment is charged immediately thereto, will constitute legally valid consideration within the tenets of contract law, thus formalizing the customer's acceptance of the bidder's offer and generating a contract. FIG. 4B illustrates an example contract generation means 411 for certifying the acceptance of an offer of a winning bid. A preamble 412 introduces a restatement of the bid parameters 403 of the winning bid and the trip parameters from the original customer request, and additional language or “biolerplate” legal text may be included at the administrator's discretion.

When the user selects a winning bid and fulfills his or her subsequent duty to enter the required personal identifying information, the system may respond in several ways, depending on the embodiment in question and/or depending upon options specified by the administrator. In a first way, the auction may be terminated and the winning bid awarded to the respective bidder. In a second way, the auction may be frozen for a period of time, such as until pick-up actually occurs or after five minutes, etc. These bid-closing options are at the discretion of the administrator and offer yet another way to customize the performance of a marketplace to suit the individual needs of its community.

After the contract is formed, there exists a marketplace relationship between the customer and the service provider, whereby the customer has the ability to communicate with the service provider via social networking means provided through the personal profile mechanism of the invention. At the end of the trip, after drop off, the customer may have the option to provide feedback or gratuity to the driver thereby. Said feedback may include a rating, a description, a personal message or greeting, and said gratuity may include a tip or some other gift. This aspect of the invention is particularly useful to customers because it also enables them to contact their driver later if some item or luggage has been accidentally left in the vehicle, or if they had developed a particularly friendly rapport with the driver and wish to assist him financially in his business, personal life, or send gifts on holidays, and so on. The types of gifts provided by the application may comprise money/cash, but may also comprise goods and services such as gift cards, mementos, greeting cards, coupons for automotive services and/or gasoline, location-specific products such as coupons to local restaurants and stores, and any other type of gift. Gift transactions and other commerce on the platform may be facilitated by third parties and made available through the social media mechanisms of the invention under the discretion of the administrator. For example, the administrator may assert control over the service providers' ability to receive different types of gifts, and furthermore each service provider may have the ability to manage these options in his or her account settings parameters. This aspect of the invention is advantageous because it encourages and incentivizes driver courtesy and best efforts, while also providing an opportunity to earn additional revenue as members of the marketplace community. Thus, each driver or service provider may have a profile page viewable to customers before and after accepting their bids wherein the registered service provider may be presented in a manner similar to a social networking service (e.g., something like a Facebook page) displaying ratings, customer feedback, gifts received and accepted, credentials, service history, business endeavors, marketing activities, and the like. An example view of a hypothetical user profile 51 manifested by the personal profile mechanism 50 is depicted in FIG. 5. In any and all of these stages of the bid submission and acceptance process, advertisements 17 and ad space 18 may be incorporated into the graphical user interface, fillable forms, or other displays of the application such as those provided by third party ad servers as is understood by persons of ordinary skill in the relevant arts.

In the personal profile 51 of FIG. 5, the personal profile mechanism 50 provides an interactive visual environment wherein the personal and professional information derived from the service provider's account such as name 52, picture 53, license 54, and contact information 55; availability parameters such as “on duty” 56; value added features such as geolocation tracking 57, feedback and comments 58, and links to other applications or stores 59; and various incentivizing features 60 of a particular registered service provider.

In another advantageous and value-added feature of the invention, the system also keeps track of a registered service provider's transaction history and can be configured to output performance data and financial summary data, and in particular may provide such data in formats amenable for commonly required purposes such as reporting income to the IRS (i.e., as a W2 or other earnings statement) or as files exportable for use in accounting software, or as required for reporting to licensing agencies, transportation and commerce regulators, or any other agency.

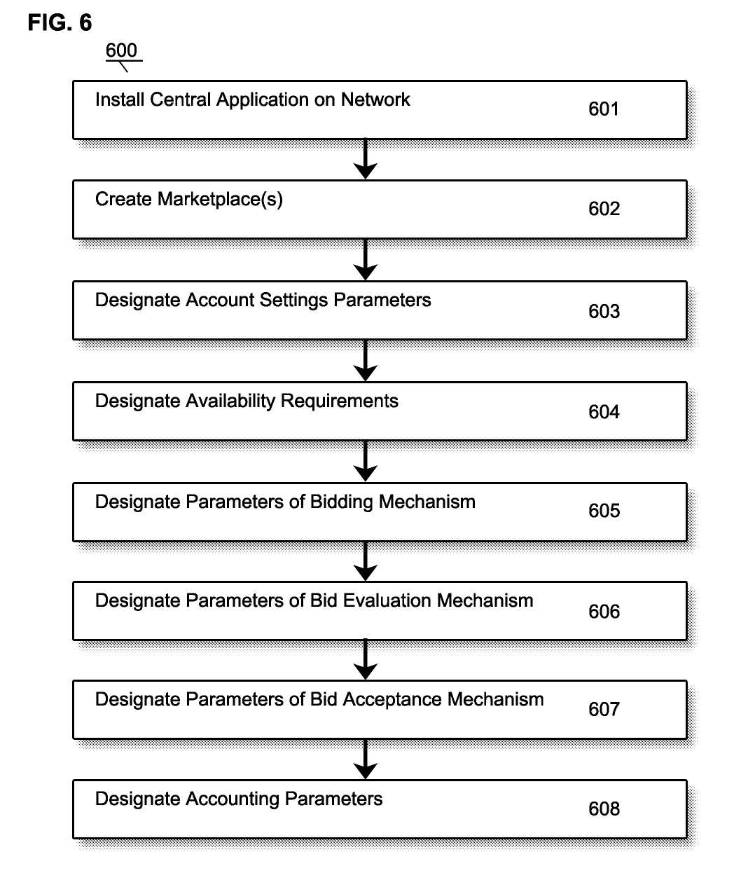

FIG. 6 provides a schematic overview of a method 600 for establishing a system of the present invention comprising the above described features. In a first step 601, an administrator installs the central application 12 of the software platform on a server and configures a network means for enabling downstream users to access the platform 10 via the consumer software application 15. In a second step 602, the administrator establishes one or more marketplaces and determines the rules and settings for each by adjusting the options in the administrator functions. The example platform established in FIG. 1 may comprise, for example, one taxi marketplace and one limousine service marketplace where users may cross-participate among both if customer request parameters warrant either service. Such a situation would arise when a large number of passengers is requested or a long-duration ride comprising multiple Destination points is desired. In a third step 603, the administrator determines what parameters will be required for service providers to register for an account, such as personal information and licensure requirements, availability indicators, and what rules and options apply to incentivizing and value-added features, as well as membership fee requirements. In a fourth step 604, the administrator determines what availability requirements must be met in order for a service provider to participate in the marketplace, which step may include setting up an interface with third-party geolocation tracking means or employee time-clocking apparatus. In a fifth step 605, the administrator sets the parameters of the bidding mechanism, comprising service request parameters, eligibility requirements, parsing operations, and the means by which bid alert notifications are handled. In a sixth step 606, the administrator sets the parameters relating to the bid evaluating mechanism, from how bids are ordered and filtered and displayed by the bid display means to what information appears in a set of displayed bid parameters. In a seventh step 607, the administrator sets the parameters of the bid acceptance mechanism, particularly the terms and language of the contract that is formed after acceptance of a bid and the terms available for payment to be made to the service provider. In an eighth step 608, accounting parameters are established which includes the format for sending a receipt and summary statement to each registered service provider and optionally, interfaces to any desired accounting and tax-preparation applications are made.

It should be emphasized that the above described embodiments of the present invention exemplify some, but not all, possible implementations of the present invention and have been set forth in order to provide a clear understanding of its qualities. Those skilled in the art will appreciate that the conception upon which this disclosure is based may readily be utilized as a basis for designing of other structures, methods, and systems for carrying out the several purposes of the present invention. The following claims should be regarded as encompassing equivalent and various constructions insofar as they do not depart from the spirit and scope of the methods and devices consistent with the present invention.

What I claim is:

1. A computerized system enabling transportation service providers to bid competitively in response to customers requests for transportation services, the system comprising:
a software platform implemented by at least one computer having at least one microprocessor, said software platform comprising a plurality of computer-executable logic and means for executing a plurality of system features, and,
a server-side application hosted on a server connected to at least one network and comprising means for establishing one or more of a virtual marketplace for buying and selling transportation services, and,
at least one user application comprising means for enabling a plurality of users to access and participate in said marketplace, wherein a first type of said users is a customer and a second type of said users is a transportation service-provider,
wherein said system features comprise:
administrator control means for enabling one or more administrators to operate and manage one or more of said virtual marketplaces and means for performing a plurality of administrator functions,
service-provider registration means for enabling each of said service providers to create and use a service-provider account comprising means for storing in a computer memory a plurality of service-provider data, said service-provider data comprising personal-identifying data elements and adjustable account-settings elements; and,
a personal profile mechanism comprising means for visually displaying one or more graphical renditions of any of said service provider data in a plurality of personal profiles, where each of said personal profiles corresponds to one of said service provider accounts and to a defined address in a computer memory location of the network, such that the personal profile is accessible for viewing by at least some of the users of the system, and means for incorporating a plurality of social media applications in said personal profiles,
wherein a marketplace community comprises all of said service provider accounts and all of said personal profiles active in one or more of said marketplaces; and,
a bidding mechanism comprising means for enabling the customer to submit at least one service request for transportation service, where said service request comprises a plurality of service-request parameters, and parsing means for identifying in the marketplace community one or more eligible service providers having an eligibility to bid in response to the service request, and alerting means for alerting each of said eligible service providers via an electronic communication of a bidding opportunity having said service-request parameters, and a bidding means for enabling each of said eligible service providers to submit a bid responsive to the bidding opportunity, where said bid comprises a plurality of bid parameters; and,
a bid-evaluating mechanism comprising means for parsing said bid, and means for organizing one or more bids into at least one responsive bid grouping, bid display means for graphically displaying the responsive bid grouping in an interactive graphical interface of the user application on an electronic device in communication with the network of the system, said interface comprising a visual representation of one or more of the bid parameters of the any bids in the bid grouping, wherein said visual representation comprises a linking means for enabling the customer to visit the personal profile of the eligible service provider corresponding to any of the bids in the bid grouping; and,
a bid-acceptance mechanism comprising means for enabling the customer to select a winning bid from the interactive graphical interface of the bid display means, a contract-formation means for obtaining an acceptance and a consideration from the customer in order to establish a contract for purchasing the winning bid, and means for transmitting a service order receipt to the service provider of the winning bid.

2. The system of claim 1, wherein said bid parameters comprise at least a bid price, a bidder name, and an incentivizing parameter.

3. The system of claim 2, where the incentivizing parameter is a financial incentive comprising an opportunity to receive all or a portion of the purchase of an additional good or service.

4. The system of claim 1, wherein said bidding mechanism further comprises a bid-price-suggestion means for calculating a recommended bid price and for transmitting said recommended bid price in the electronic communication of the alerting means.

5. The system of claim 1, wherein said service-provider data comprises one or more value-added parameters.

6. The system of claim 5, where said value-added parameter comprises a geolocation value and an estimated-time-of-arrival parameter.

7. The system of claims 5, where said value added parameter comprises a data provided by one or more of the social media applications.

8. The system of claim 1, further comprising availability indication means for enabling the service-provider to inform the platform of a present status affecting the readiness of the service provider to provide a particular transportation service.

9. The system of claim 1, wherein said service provider registration means further comprises means for enabling the service provider to submit a proof of an official documentation.

10. The system of claim 1, wherein said social media platform comprises third-party commerce means for enabling customers to buy one or more goods and services via one or more software-enabled objects embedded in the personal profile mechanism.

11. The system of claim 1, further comprising a feedback means for enabling customers to submit feedback regarding a service request for which a contract was formed.

12. A method for hosting one or more virtual marketplaces on a networked computer platform whereby customers seeking transportation services may submit a request for receiving specific transportation services and whereby a plurality of service providers may competitively bid for said customer request by submitting bids directed thereto, the method comprising the steps of:
providing a user-end software application means for enabling users to access and use said marketplace on said platform from a personal computing device;
providing an enrollment means for enrolling each service provider in an account on the marketplace, where said account comprises a plurality of service provider data, one or more availability parameters, and one or more value-added parameters;
generating a personal profile comprising social media content for each of the accounts;
providing a service request submission means for enabling said customers to submit said requests for service, where said requests comprise service request parameters, and where said submission means comprises a parsing means for identifying one or more eligible service providers in the marketplace;
sending an alert notification of an opportunity to bid via an alerting means to each of said eligible service providers;
providing a bidding mechanism for enabling each of said alerted eligible bidders to respond by submitting a responsive bid to the platform;
evaluating all of said responsive bids and returning a responsive bid grouping to the requesting customer, where said responsive bid grouping is displayed in a graphical format in the user-end software application means;
directing the requesting customer to a viewing of the personal profile of each of the service providers of the responsive bids;
receiving a winning bid selection from the requesting customer; and,
receiving a consideration from the requesting customer, thereby generating a contract for the requested service between the requesting customer and the service provider of the winning bid selection;
thereby achieving the sale of the specific transportation service via the marketplace.
